(19) United States
(12) Patent Application Publication
(10) Pub. No.: US 2019/0353619 A1
(43) Pub. Date: Nov. 21, 2019

(54) ULTRASENSITIVE ACOUSTIC WAVE RESONATOR DEVICE HAVING A REPLACEABLE FILMS AND METHODS THEREOF

(71) Applicant: University of Massachusetts, Boston, MA (US)

(72) Inventors: Hongwei Sun, Lexington, MA (US); Hamed Esmaeilzadehkhosravieh, Lowell, MA (US)

(21) Appl. No.: 16/414,682

(22) Filed: May 16, 2019

Related U.S. Application Data
(60) Provisional application No. 62/672,881, filed on May 17, 2018.

(51) Int. Cl. G01N 29/02; G01N 29/036

(52) U.S. Cl. CPC G01N 29/022; G01N 2291/0256; G01N 29/036

(57) ABSTRACT

The invention provides novel acoustic wave resonator devices and microbalances. More particularly, the invention provides quartz crystal microbalances with ultra-high sensitivity and methods of fabrication thereof.

### PRIORITY CLAIMS AND RELATED PATENT APPLICATIONS

This application claims the benefit of priority to U.S. Provisional Application Ser. No. 62/672,881, filed on May 17, 2018, the entire content of which is incorporated herein by reference.

### TECHNICAL FIELDS OF THE INVENTION

The invention generally relates to acoustic wave resonator devices and microbalances. More particularly, the invention relates to quartz crystal microbalances with ultra-high sensitivity and method of fabrication thereof.

### BACKGROUND OF THE INVENTION

Thickness shear mode (TSM) resonators, widely referred to as quartz crystal microbalance (QCM) sensors, are traditionally used for deposition control of thin films. The operating principle of QCM sensors is based on the fact that the change in the resonant frequency of a vibrating quartz crystal resonator is proportional to the mass of the deposited film. (Ballantine, et al. 1997 Acoustic wave sensors: Theory, design and physical-chemical applications 1st ed.: Academic press.)

QCMs have been extensively used in sensing mass loadings with extremely high sensitivity (<10 ng/cm²). A QCM device typically consists of a thin disk of AT-cut quartz crystal with circular electrodes patterned on both sides. Due to the piezoelectric properties and crystalline orientation of the quartz, the alternating voltage between the electrodes results in shear waves within the crystal. For this reason, QCM is sometimes referred to as a thickness shear mode resonator (TSM) in the literature. With a film with certain mass attached on one side of the electrode, the resonant properties such as resonant frequency and bandwidth of a QCM will change accordingly.

The relationship between the change in QCM resonant frequency (Δf) and the surface mass density (Δm/A) can be described under the Sauerbrey theory as:

$$Δ f = - \frac{2 {f}_{0}^{2}}{\sqrt{{μ}_{q} {ρ}_{q}}} \frac{Δ m}{A} \qquad ( 1 )$$

where f₀ is the fundamental resonant frequency of the QCM without any mass loading, while ρ_{q} (2648 g/cm³), and μ_{q} (29.47 dyn/cm²) are the density and shear modulus of quartz crystal, respectively. (Sauerbrey 1959 Zeitschrift für Physik 155, 206-222.)

Major drawbacks of traditional QCM devices are their relatively low sensitivity and the need to replace a QCM after each use which significantly increases the costs of sensing. Different techniques have been studied to coat sensing films on QCM substrates.

Yoo and Bruckenstein used dip-coating to fabricate poly(methylmethacrylate) (PMMA) films with various void volumes on QCM substrates. Their water vapor measurement showed a 3.7 fold sensitivity enhancement in comparison to a PMMA film without voids. (Yoo, et al. 2013 Analytica Chimica Acta 785, 98-103.) Sakti et al. employed a spin-coating technique to coat polystyrene on QCM surfaces to evaluate the influence of solvent on the surface roughness of the deposited film. Their results illustrated no significant difference between the frequency of QCMs covered with polystyrene prepared in chloroform, toluene, xylene and tetrahydrofuran (THF) solvents. (Sakti, et al. 2016 AIP Conference Proceedings 1719 (1), 030017.) Fukao et al. developed spray layer-by-layer (spray-LBL) deposition to study the in-situ development of multiple layers of polyelectrolyte on the gold surface of a QCM sensor. Their new fabrication technique showed nanoscale accuracy for control of film thickness. (Fukao, et al. 2011 Macromolecules 44 (8), 2964-2969.) Okahata et al. studied Langmuir-Blodgett (LB) films in air and liquid environments using QCM. (Okahata, et al. 1989 J. Am. Chem. Soc. 111 (26), 9190-9194.) LB films are ultrathin films prepared by spreading a single molecule layer on a water surface and transferring it onto a solid surface (Oliveira 1992 Brazilian Journal of Physics 22 (2)). Okahata et al. showed that QCM could measure the fluidity change variation of LB films in distilled water. Percival et al. demonstrated a casting method to fabricate molecularly imprinted polymer (MIP) as a thin permeable film on QCM substrates. The resulting device was used to determine the concentration of L-menthol in the liquid phase. (Percival, et al. 2001 Analytical Chemistry 73 (17), 4225-4228.) In addition, mica was successfully glued on a QCM substrate with a UV-curable glue to achieve a new acoustic device which was sensitive enough for measurement of interfacial friction phenomena. (Berg, et al. 2002 Physical Review E 65 (2), 026119; Berg, et al. 2002 J Appl. Phys. 92 (11), 6905-6910). The resulting acoustic device was then employed to investigate immobilization procedures in liquid environments. (Richter, et al. 2004 Langmuir 20 (11), 4609-4613.) However, gluing a thin piece of mica on a solid substrate is always challenging as mica is very fragile and the glue disturbs the resonance of system due to its large energy dissipation. (Berg, et al. 2003 Review of Scientific Instruments 74 (8), 3845-3852.)

Recently, Wang et al. attached a PMMA micropillar film on the QCM substrates by thermal nanoimprinting lithography (T-NIL). (Wang, et al. 2014 J Appl. Phys. 115 (22), 224501.) The micropillar and QCM (QCM-P) formed a two degree of freedom vibration system possessing a coupled resonance between the QCM substrate and the micropillar. This device was used to detect humidity and showed much larger frequency shifts compared to a traditional sensor. (Wang, et al. 2014 J Appl. Phys. 115 (22), 224501; Su, et al. 2018 Biosensors and Bioelectronics 99, 325-331.) Developed by Chou et al., NIL can generate nanopatterns using direct contact between a mold and a resist substance, which successfully eliminates the restrictions of light deflections or ray scattering of traditional techniques. (Chou, et al. 1996 Science 272 (5258), 85-87; Guo 2007 Advanced Materials 19 (4), 495-513.) This technique embosses a rigid stamp with micro/nanoscale features onto a resist substance at certain temperatures and pressures. Curing via heating or UV light during the stamping hardens the polymeric nanostructures to give them excellent mechanical properties. (Esmaeilzadeh, et al. 2015 The Effects of Material Properties on Pillar-Based QCM Sensors 57533, V010T13A028.) Using NIL technique, sub-10 nm features was successfully imprinted which might not be enabled by conventional techniques (Guo 2004 J of Phys. D: Applied Physics, 37 (11), R123).

Therefore, there remains an ongoing need for QCM devices and methods that provide improved sensitivity with cost of operation.

### SUMMARY OF THE INVENTION

The invention provides ultrasensitive acoustic wave resonator devices having a replaceable film, e.g., QCMs with ultra-high sensitivity, and methods of preparation and use thereof.

In one aspect, the invention generally relates to a quartz crystal microbalance resonator, which includes: a replaceable layer of a resonant material; and a quartz oscillator having a surface and having electrical input terminals. The replaceable layer of a resonant material is glued to the surface of the quartz oscillator. The quartz crystal microbalance resonator having at least one characteristic resonant frequency.

In yet another aspect, the invention generally relates to an article of manufacture that includes a quartz crystal microbalance resonator disclosed herein.

In yet another aspect, the invention generally relates to a method for fabricating a quartz crystal microbalance resonator. The method includes: providing a quartz oscillator having a surface and having electrical input terminals; providing a nanoimprint lithography mother mold; providing a transfer mold using the nanoimprint lithography mother mold as a template; preparing a replaceable layer of a resonant material using the transfer mold; and gluing the replaceable layer of a resonant material to the surface of the quartz oscillator.

In yet another aspect, the invention generally relates to a quartz crystal microbalance resonator fabricated according to a fabrication method disclosed herein.

In yet another aspect, the invention generally relates to a method for detecting or measuring humidity. The method includes: contacting an environment to be tested for humidity with a quartz crystal microbalance resonator disclosed herein; and measuring a frequency response of the quartz crystal microbalance resonator to detect or measure the humidity of the environment

In yet another aspect, the invention generally relates to a method for detecting or measuring protein absorption. The method includes: contacting a protein to be tested for absorption with a quartz crystal microbalance resonator disclosed herein; and measuring a frequency response of the quartz crystal microbalance resonator to detect or measure protein absorption.

### BRIEF DESCRIPTION OF THE FIGURES

FIG. 1 shows an exemplary QCM-P sensor fabricated by attaching a micropillar film on the QCM substrate.

FIG. 2 shows fabrication steps of QCM-F and QCM-P devices: (1) deposition of a glue droplet and spin-coating of glue on a QCM substrate, (2) applying UV light to a pair of QCM and PDMS stamp; and (3) release of PMMA micropillar films from the PDMS stamp.

FIG. 3 shows exemplary comparison of theoretical predictions of QCM-P operating in air and water with experimental validation results. The frequency data was normalized by the resonance frequency of the bare QCM.

FIG. 4 shows exemplary measured Q-factors when QCM-P devices operated in air and water under different heights.

FIG. 5 shows exemplary eflection loss curves of QCM coated with glue solution: (a) during solvent evaporation and initial changes in the glue layer for up to 80 minutes after spin coating, and (b) after applying UV light for up to 20 minutes; (c) Resonant frequency and Q-factor after spin coating of glue solution and applying UV light.

FIG. 6. a) Schematic of three different QCM-F type devices obtained by gluing a uniform PMMA film on QCM, traditional QCM-F, and QCM coated with glue (control). b) Responses of the three different sensors in (a) during water absorption.

FIG. 7. (a)-(e) Frequency shift during humidity detection using glued QCM-F and QCM-P with pillar heights of a) h=5 μm, b) h=10 μm, c) h=14.5 μm, d) h=17.5 μm, e) h=22 μm. f) Frequency shift of QCM-P divided by that of QCM-F (sensitivity enhancement) versus pillar height.

FIG. 8 shows schematic of experimental setup for humidity detection.

FIG. 9 shows exemplary experimental setup for bovine serum albumin (BSA) protein immobilization measurement. (Inserts: top and front views of the flow cell).

FIG. 10. a) Frequency shift response of QCM-F and QCM-P with pillar height of 12 μm to the BSA adsorption on plasma modified PMMA with BSA concentration of 1500 nM, b) QCM-P response due to BSA concentration of 200 nM to 1500 nM.

### DETAILED DESCRIPTION OF THE INVENTION

The invention provides ultrasensitive acoustic wave resonator devices having a replaceable film, e.g., quartz crystal microbalances with ultra-high sensitivity, and methods thereof.

A key feature of the present invention is that for the first time glue is used to attach flat or micropillar films onto QCM substrates for sensing applications. More importantly, the QCM glued with PMMA micropillar film on the QCM substrate show dramatic (more than 8 times) improvement in sensitivity over traditional QCM devices. Major benefits over the prior art include the followings: (1) the films for QCM sensors may be made to be replaceable, which behave like a sticker; (2) the fabrication of QCM sensors involves a gluing step of a film on the QCM substrate (or vice versa) while previously fabrication of QCM sensors involves expensive and costly processes and specially designed equipment are required for the coating films on QCM substrates; (3) the glued QCM-P sensors showed significant improvement in sensitivity over traditional QCM sensors.

In one aspect, the invention generally relates to a quartz crystal microbalance resonator, which includes: a replaceable layer of a resonant material; and a quartz oscillator having a surface and having electrical input terminals. The replaceable layer of a resonant material is glued to the surface of the quartz oscillator. The quartz crystal microbalance resonator having at least one characteristic resonant frequency.

In certain embodiments, the replaceable layer of a resonant material is releasably glued to the surface of the quartz oscillator.

In certain embodiments, the replaceable layer of a resonant material is not releasably glued to the surface of the quartz oscillator.

In certain embodiments, the replaceable layer of a resonant material is a flat film of substantially uniform thickness. In certain embodiments, the replaceable layer of a resonant material has a substantially uniform thickness in the range from about 1 μm to about 10 μm (e.g., from about 3 μm to about 10 μm, from about 5 μm to about 10 μm, from about 7 μm to about 10 μm, from about 1 μm to about 7 μm, from about 1 μm to about 5 μm, from about 1 μm to about 3 μm, from about 3 μm to about 6 μm).

In certain embodiments, the replaceable layer of a resonant material includes a plurality of micropillars of the resonant material in an array, each of the micropillars having a diameter, a length, and a spacing, the plurality of micropillars in mechanical communication with the surface of the quartz oscillator.

In certain embodiments, the at least one characteristic resonant frequency has a dependence on one or more of the diameter, the length, and the spacing of the plurality of micropillars.

In certain embodiments, the length of the plurality of micropillars is substantially uniform and is in the range from about 1 μm to about 30 μm (e.g., 5 μm to about 30 μm, 10 μm to about 30 μm, 15 μm to about 30 μm, 20 μm to about 30 μm, 1 μm to about 20 μm, 1 μm to about 15 μm, 1 μm to about 10 μm, 1 μm to about 5 μm, 5 μm to about 20 μm, 5 μm to about 10 μm).

In certain embodiments, the diameter of the plurality of micropillars is substantially uniform and is in the range from about 1 μm to about 25 μm.

In certain embodiments, the spacing of the plurality of micropillars is substantially uniform and is in the range from about 2 μm to about 40 μm.

Any suitable materials may be used as the resonant material. In certain embodiments, the resonant material includes a polymer. In certain embodiments, the resonant material is a polymer.

In certain embodiments, the resonant material comprises polymethyl methacrylate (PMMA). In certain embodiments, the resonant material is PMMA.

In certain embodiments, the replaceable layer of a resonant material is glued (e.g., releasably or not releasably) to the surface of the quartz oscillator by a UV-curable glue.

Any suitable UV-curable glues may be employed. In certain embodiments, the UV-curable glue is a Norland optical adhesive. Other suitable UV-curable glues include Permabond UV curable adhesive, Masterbond UV curable adhesive, Loctite UV light cure adhesive, Parlite UV curable adhesives, Cyberbond UV curing adhesives, etc.

In certain embodiments, the replaceable layer of a resonant material is glued (e.g., releasably or not releasably) to the surface of the quartz oscillator by a hot-pressed glue.

Any suitable hot-pressed glues may be employed. In certain embodiments, the hot-pressed glue is a Norland optical adhesive. Other suitable hot-pressed glues include Kleiberit hot press glue, Franklin Adhesives, Blaze 120 hot-pressed glue, etc.

In certain embodiments, the quartz crystal microbalance resonator is configured to operate in contact with a fluid medium. Any suitable fluid medium may be employed. In certain embodiments, the fluid medium is a gas (e.g., air, nitrogen). In certain embodiments, the fluid medium is a liquid gas (e.g., water, body fluids).

In certain embodiments, the quartz crystal microbalance resonator is configured to modify the at least one characteristic resonant frequency in response to a quantity of adsorbed material on the replaceable layer.

In yet another aspect, the invention generally relates to an article of manufacture that includes a quartz crystal microbalance resonator disclosed herein.

In yet another aspect, the invention generally relates to a method for fabricating a quartz crystal microbalance resonator. The method includes: providing a quartz oscillator having a surface and having electrical input terminals; providing a nanoimprint lithography mother mold; providing a transfer mold using the nanoimprint lithography mother mold as a template; preparing a replaceable layer of a resonant material using the transfer mold; and gluing the replaceable layer of a resonant material to the surface of the quartz oscillator.

In certain embodiments, gluing the replaceable layer to the surface of the quartz oscillator forms a releasably glued replaceable layer on the surface of the quartz oscillator.

In certain embodiments, gluing the replaceable layer to the surface of quartz oscillator forms a non-releasably glued replaceable layer on the surface of the quartz oscillator.

In certain embodiments, gluing the replaceable layer of a resonant material to the surface of the quartz oscillator includes: treating the surface with plasma to clean the surface; and spin coating a glue solution to form a thin uniform layer on the surface.

In certain embodiments, gluing the replaceable layer of a resonant material to the surface of the quartz oscillator includes: treating a surface of the replaceable layer of a resonant material; and spin coating a glue solution to form a thin uniform layer on the surface of the replaceable layer of a resonant material.

Any suitable UV-curable glues may be employed. In certain embodiments, the UV-curable glue is a Norland optical adhesive. Other suitable UV-curable glues include Permabond UV curable adhesive, Masterbond UV curable adhesive, Loctite UV light cure adhesive, Parlite UV curable adhesives, Cyberbond UV curing adhesives, etc.

In certain embodiments, gluing the replaceable layer of a resonant material to the surface of the quartz oscillator includes: treating the surface with plasma to clean the surface; and applying a hot glue to form a thin uniform layer on the surface.

Any suitable hot-pressed glues may be employed. In certain embodiments, the hot-pressed glue is a Norland optical adhesive. Other suitable hot-pressed glues include Kleiberit hot press glue, Franklin Adhesives, Blaze 120 hot-pressed glue, etc.

In certain embodiments, the replaceable layer of a resonant material is a flat film of substantially uniform thickness. In certain embodiments, the replaceable layer of a resonant material has a substantially uniform thickness in the range from about 1 μm to about 10 μm (e.g., from about 3 μm to about 10 μm, from about 5 μm to about 10 μm, from about 7 μm to about 10 μm, from about 1 μm to about 7 μm, from about 1 μm to about 5 μm, from about 1 μm to about 3 μm, from about 3 μm to about 6 μm).

In certain embodiments, the replaceable layer of a resonant material includes a plurality of micropillars of the resonant material in an array, each of the micropillars having a diameter, a length, and a spacing, the plurality of micropillars in mechanical communication with the surface of the quartz oscillator.

In certain embodiments, the at least one characteristic resonant frequency has a dependence on one or more of the diameter, the length, and the spacing of the plurality of micropillars.

In certain embodiments, the length of the plurality of micropillars is substantially uniform and is in the range from about 1 μm to about 30 μm (e.g., 5 μm to about 30 μm, 10 μm to about 30 μm, 15 μm to about 30 μm, 20 μm to about 30 μm, 1 μm to about 20 μm, 1 μm to about 15 μm, 1 μm to about 10 μm, 1 μm to about 5 μm, 5 μm to about 20 μm, 5 μm to about 10 μm).

In certain embodiments, the diameter of the plurality of micropillars is substantially uniform and is in the range from about 1 μm to about 25 μm (e.g., about 1 μm to about 20 μm, about 1 μm to about 15 μm, about 1 μm to about 10 μm, about 1 μm to about 5 μm, about 5 μm to about 25 μm, about 10 μm to about 25 pm, about 15 μm to about 25 μm).

In certain embodiments, the spacing of the plurality of micropillars is substantially uniform and is in the range from about 2 μm to about 40 μm (e.g., from about 2 μm to about 30 μm, from about 2 μm to about 20 μm, from about 2 μm to about 10 μm, from about 2 μm to about 5 μm, from about 5 μm to about 40 μm, from about 10 μm to about 40 μm, from about 15 μm to about 40 μm, from about 20 μm to about 40 μm).

In certain embodiments, the density of the plurality of micropillars is about 200 (count) per mm² (area) to about 120,000 per mm² (e.g., about 200 per mm² to about 1,000 per mm², about 1,000 per mm² to about 10,000 per mm², about 10,000 per mm² to about 50,000 per mm², about 50,000 per mm² to about 120,000 per mm²).

Any suitable materials may be used as the resonant material. In certain embodiments, the resonant material includes a polymer. In certain embodiments, the resonant material is a polymer.

In certain embodiments, the resonant material comprises polymethyl methacrylate (PMMA). In certain embodiments, the resonant material is PMMA.

In certain embodiments, the nanoimprint lithography mother mold comprises SU-8 resin. SU-8 is an epoxy-based negative photoresist having excellent mechanical properties and chemical resistance. SU-8 3000 series (MicroChem) was used to generate mother mold of NIL. The SU-8 films with different thickness were spin coated and micron sized holes were fabricated with conventional photolithography method.

In certain embodiments, the transfer mold comprises polydimethylsiloxane (PDMS).

In yet another aspect, the invention generally relates to a quartz crystal microbalance resonator fabricated according to a fabrication method disclosed herein.

In yet another aspect, the invention generally relates to a method for detecting or measuring humidity. The method includes: contacting an environment to be tested for humidity with a quartz crystal microbalance resonator disclosed herein; and measuring a frequency response of the quartz crystal microbalance resonator to detect or measure the humidity of the environment

In yet another aspect, the invention generally relates to a method for detecting or measuring protein absorption. The method includes: contacting a protein to be tested for absorption with a quartz crystal microbalance resonator disclosed herein; and measuring a frequency response of the quartz crystal microbalance resonator to detect or measure protein absorption.

The disclosed invention may be utilized in diverse industries for a variety of applications including, for example, gas and liquid sensors, biosensors, thin film deposition measurement, affinity of molecules (proteins) to surfaces detection, interactions between biomolecules, probing solid/liquid interface, viscoelastic properties of polymers, etc.

### EXAMPLES

### Fabrication

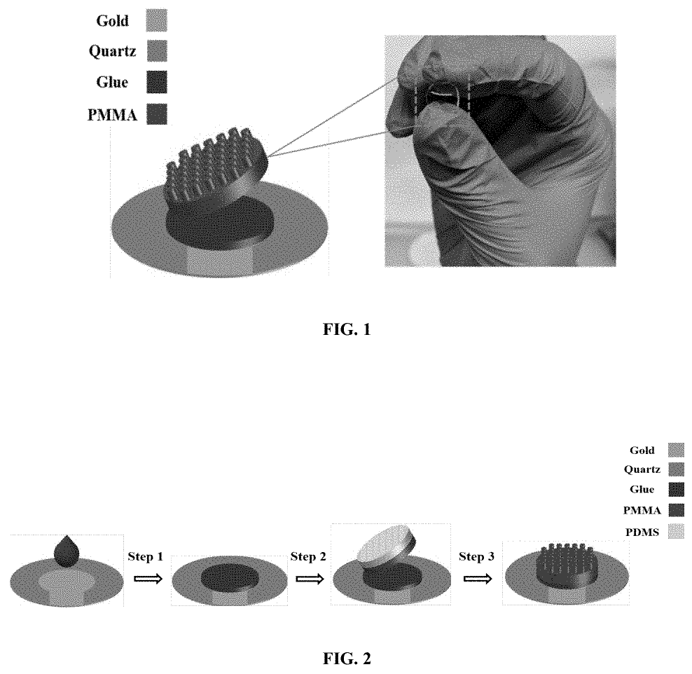

Two acoustic wave resonator devices were fabricated using QCM substrates: Film-based QCM (QCM-F) and micropillar-based QCM (QCM-P) by gluing a replaceable PMMA flat film and PMMA micropillar films, respectively. FIG. 1 illustrates a one-step fabrication method in which a flexible PMMA micropillar film was attached on the QCM substrate directly using UV-curable glue (QCM-P). PMMA is a transparent thermoplastic with low coefficient of thermal expansion and pressure shrinkage.

FIG. 2 illustrates the detail of an exemplary fabrication procedure, including (1) depositing the glue droplet on a QCM substrate and spin coating of the glue; (2) attachment of a micropillar-PDMS mold film on the QCM substrate; and (3) curing of the glue under UV light to achieve a reliable attachment of films on the substrate. The reliability was examined through at least 100 measurements of QCM glued with film to ensure the repeatability of the experimental results. In the first step, the glue as purchased was diluted in the acetone solvent at a weight ratio of 1:10 and the resulting solution was spin-coated at 5000 rpm for 60 seconds to form a uniform layer on the QCM. After the spin coating, the QCM coated with the glue film was put on a flat substrate for 5 to 10 minutes to allow the solvent to evaporate. In the second step, polydimethylsiloxane (PDMS) mold-PMMA film pair was pressed onto the QCM substrate. At last, UV light (UV power: 500 W, Wavelength: 170 nm-2500 nm) was applied to the pair so that the glue cross-linked and formed a permanent bond between film and QCM substrate. Then the PDMS stamp was peeled off from the QCM substrate and only the PMMA micropillar film was left on the substrate.

The PMMA flat film layer with a thickness of 2.3 μm and micro-pillars films with different pillar heights from 5 μm to 22 μm were fabricated on QCM substrate. FIG. 3 presents the normalized frequency shifts (the measured frequency shifts were divided by the nominal resonance frequency of the bare QCM) of the QCM-P devices based on theoretical model and experimental measurement results. It should be pointed out that the residual layer and glue film was treated as rigid layers in the analysis. As can be seen, the theoretical results are in an excellent agreement with experimental measurements. The results show that the frequency shift of the QCM-P sensor dropped linearly with increasing pillar height, which is consistent with what was predicted by the Sauerbrey theory. However, when the pillars approached the critical height, an abrupt “dip and jump” occurred due to the coupled resonance of the QCM and micropillar vibrations.

Another key parameter in the QCM-P frequency response is the Quality factor (Q-factor). The Q-factor is defined as follows:

Q_{factor}=f/T (2)

where f is the resonant frequency of the QCM-P sensor while F is the bandwidth where the resonant frequency reaches the half of its maximum value. (Rodahl, et al. 1995 Review of Scientific Instruments 66 (7), 3924-3930.) A high Q-factor results in a sharp impedance curve and thus a good frequency resolution.

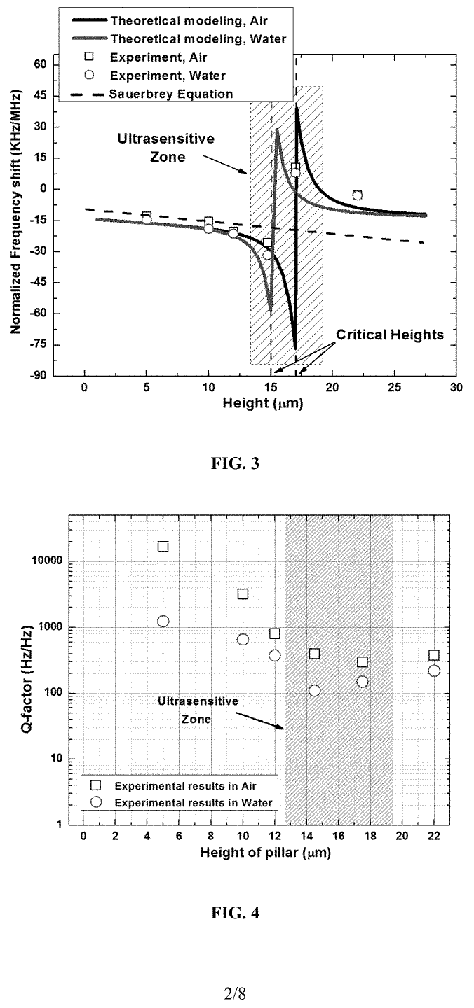

FIG. 4 shows the measured Q-factors when the QCM-P devices operated in air and water under a completely wetted state. It can be seen that the Q-factor reduced to low values when the pillar height was approaching the ultrasensitive zone (shaded area in FIG. 4). The following reasons are believed to be behind the observations: (1) a much larger energy dissipation took place in the micropillars when the QCM-P device is near the resonance (which is also a common phenomenon for majority of resonators); and (2) a much stronger liquid-micropillar interaction also contributed to the low Q-factor values near the resonance. (Su, J. “Investigation of the interaction between liquid and micro/nanostructured surfaces during condensation with quartz crystal microbalance” Ph.D. thesis, University of Massachusetts Lowell, 2017.) The minimum value of Q-factor that could be detected by the current network analyzer system was around 300. As a result, the micropillar with the height of 12 μm was utilized to measure the physical adsorption of BSA.

Measurement of QCM with Glued Films

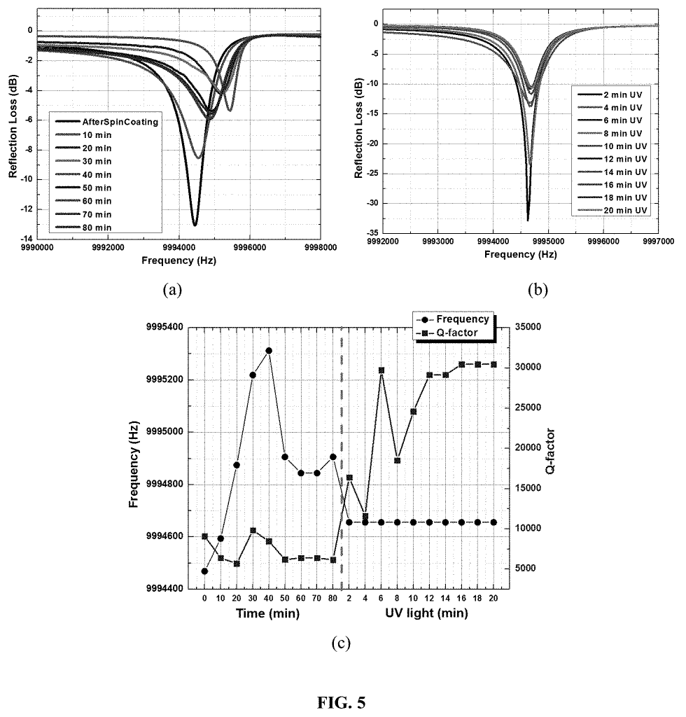

The effect of the glue layer on the QCM response was studied. The glue was diluted in acetone solvent at a weight ratio of 1:10 and then spin-coated on a QCM substrate at 5000 rpm for 60 seconds. The coated QCM device was then placed on a flat surface to remove the solvent in the glue film. During the drying process, the reflection loss of the QCM device was measured every 10 minutes. The results are shown in FIG. 5(a). After drying, the glue-coated QCM was exposed to UV light generated from a Mask Aligner (COBILT, CA-800) for 20 minutes. The QCM-P sensor signal was measured every 2 minutes during the curing cycle, as shown in FIG. 5(b). In addition, the Q-factor was measured and used to determine the rigidity of the glue layer. A higher Q-factor corresponds to a sharper reflection loss curve and thus to a higher rigidity of the glue layer. FIG. 5(c) presents the data of resonant frequency and Q-factor of the QCM during the drying of glue film and UV light treatment. As can be seen in FIG. 5(c), the frequency first increased due to solvent evaporation from the glue film, which lasted about about 30˜40 minutes, followed by a decrease due to the chemical reactions occurring in the glue film during exposure to ambient visible light. After UV exposure (right side of FIG. 5(c)), the resonant frequency decreased and finally became steady. The Q-factor, however, was not stable and gradually increased, eventually reaching constant value due to polymer crosslinking in the glue.

Experiments were carried out using film-based QCM (QCM-F) and pillar-based QCM (QCM-P) devices to detect humidity and BSA protein attachment to the sensor surfaces.

### A. Humidity Detection Using QCM-F and QCM-P

The detection of humidity is crucial for various applications such as industrial process control (Carr-Brion, K., Moisture sensors in process control. Elsevier Applied Science Publishers; New York, N.Y., USA, 1986), agriculture (Chavan, et al. 2014 Int. J Engin. Trends and Tech. (IJETT) 11 (10), 493-497), air conditioning (Nie, et al. 2014 Microsys. Tech. 20 (7), 1311-1315) and structural health monitoring systems (Comisu, et al. 2017 Procedia Engin. 199, 2054-2059).

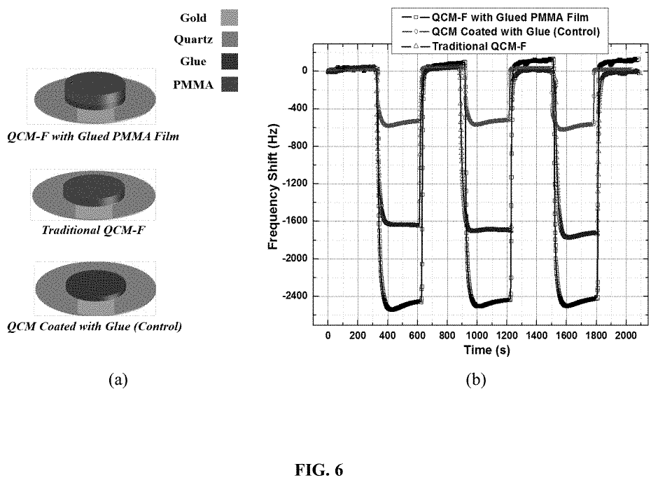

In this experiment, the frequency responses of QCM-F and QCM-P devices with glued films for humidity detection were studied. FIG. 6(a) shows the schematic of three different sensors: QCM-F (with a uniform PMMA film glued on the QCM), traditional QCM-F (with a PMMA film spin coated on the QCM), and QCM coated with UV-curable glue as the control sensor. First, the responses of three QCM devices were measured in air to achieve a steady baseline. The sensors were then placed in a bottle, which contained DI water at 25° C. Due to humidity absorption, the frequency of sensors started decreasing until it became saturated. At last, the sensors were exposed to ambient air environment and the devices signal went back to its initial level. This procedure was carried out three times to check the repeatability of results. FIG. 6(b) shows the frequency responses due to humidity absorption for the three different sensors.

The results confirmed that the glued QCM-F sensor had the same frequency shift as the traditional QCM-F sensor after removing the frequency shift due to the glue. In other words, QCM coated with glue (control sensor) absorbed some humidity.

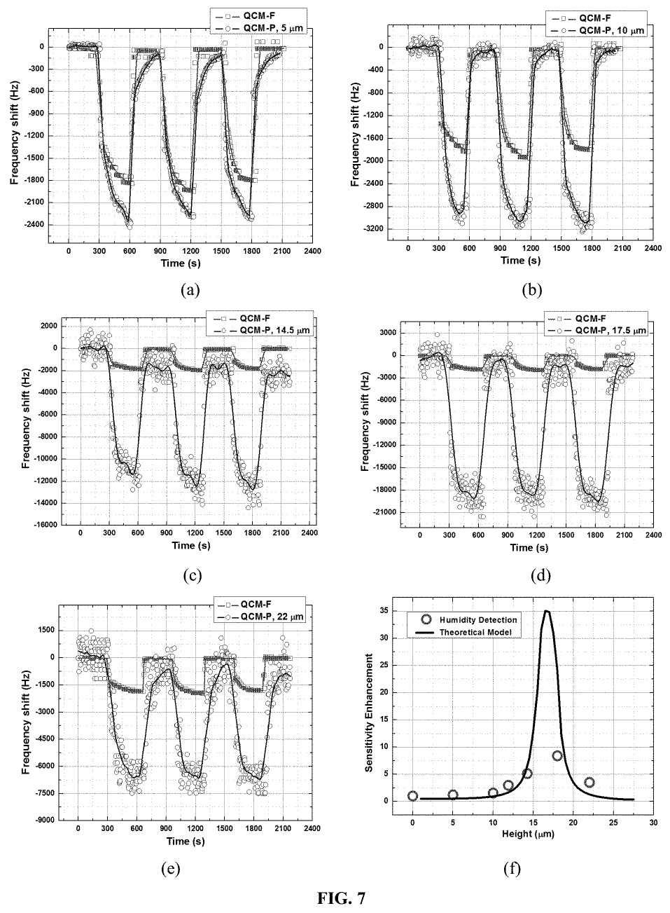

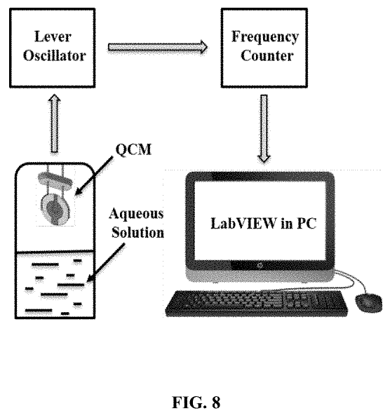

The frequency responses of the new QCM-P devices with glued pillar films with different pillar heights (5 μm, 10 μm, 15 μm and 17.5 μm) and the glued QCM-F sensors were tested for humidity adsorption and the results are presented in FIGS. 7(a)-(e). The results show that the QCM-P demonstrated significant enhancement in sensitivity over the glued QCM-F and 8.5 times improvement in sensitivity was achieved by QCM-P in comparison to QCM-F, when the pillar height was 17.5 μm as shown in FIG. 7(f).

### B. Measurement of Immobilization of BSA Protein on Modified PMMA

The immobilization of protein is an important process in natural surroundings and laboratory processes and has been widely utilized in biophysics and biotechnology including contact lenses, implants, systems for the purification of proteins (chromatography) and substrates for enzyme-linked immunosorbent assays (ELISA). (Valero et al. 2010 Colloids and Surfaces B: Biointerfaces, 80 (1), 1-11; Ostuni, et al. 2003 Langmuir 19 (5), 1861-1872; Santos, et al. 2007 Contact Lens and Anterior Eye 30 (3), 183-188; Liping, et al. 2008 Curr. Topics in Med. Chem. 8 (4), 270-280; Murphy, et al. 2011 J Visual. Exp. (55), 3060; Gibbs, J., Immobilization principles—Selecting the surface. ELISA Technical Bulletin, Corning Incorporated Life Sciences, New York 2001.)

The immobilization of BSA has been extensively studied to evaluate the hemocompatibility of biomaterials. (Ying, et al. 2004 Colloids and Surfaces B: Biointerfaces, 33 (3-4), 259-263.) QCM provides real-time immobilization measurement of biomolecules on solid surfaces with no requirement of fluorescent indicator or expensive setup. (Thourson, et al. 2013 Colloids and Surfaces B: Biointerfaces 111, 707-712), (Niklas, et al. 2017 J Micromech. and Microengin. 27 (12), 124001.)

In this invention, the glued QCM-F and QCM-P sensors, for example, with micropillar height of 12 μm, were used to measure the immobilization of BSA on modified PMMA surfaces. The PMMA surfaces were treated with an oxygen plasma (PDC-32G, Harrick Plasma) for 10 seconds to make surfaces superhydrophilic before each measurement.

The experimental setup for humidity measurement using QCM-F and QCM-P is shown in FIG. 8. The QCM devices were driven with a lever oscillator (ICM 35366-10, Oklahoma, Okla.), and the resonant frequency was read by a frequency counter (BK 1823A, Fotronic Corp., Melrose, Mass.). Measurements were recorded every second by a PC with a built-in Lab VIEW program.

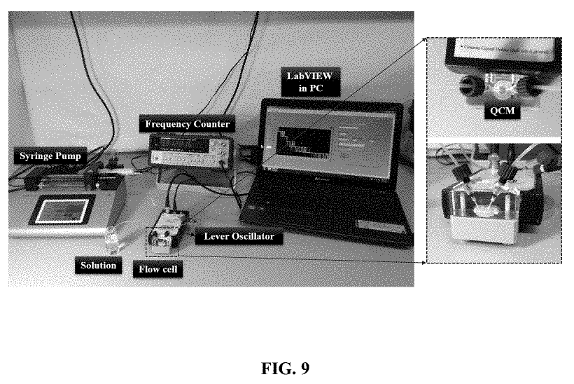

The experimental setup for BSA measurement, shown in FIG. 9, includes a flow cell (integrated with QCM sensor), flow delivery and frequency measurement components. The QCM sensor (QCM-F or QCM-P) was mounted in a flow cell kit (ALS Co, Japan) by sandwiching the sensor between two rubber 0-rings, with only the top surface of the sensor being in contact with the fluid/reagent, while the back side of the sensor is exposed to ambient air. Fluid flow was initiated through a syringe pump (KD Scientific Legato 101) from a centrifuge tube, which can hold 1.5 mL of reagent. The sensor was actuated by a Lever oscillator (ICM 35366-10, Oklahoma, Okla.) and the resonant frequency was read by a frequency counter (BK 1823A, Fotronic Corp., Melrose, Mass.). The frequency data were finally recorded with a built-in Labview program (National Instruments, TX). It has been reported that oxygen plasma treatment can improve both biocompatibility and surface wettability of polymeric materials when compared to the pristine, untreated condition. (Liu, et al. 2004 Mater. Chem. and Phys. 85(2): p. 340-346; Liu, et al. 2004 Surface and Coatings Tech. 185(2): p. 311-320; Rezaei, et al. 2016 Applied Surface Sci. 360, Part B: p. 641-651.) For instance, a QCM dissipation (QCM-D) sensor coated with PMMA film and plasma treated demonstrated faster adsorption kinetics in contrast to the pristine PMMA surface. (Liu, et al. 2008 J Bionic Engin. 5(3): p. 204-214.)

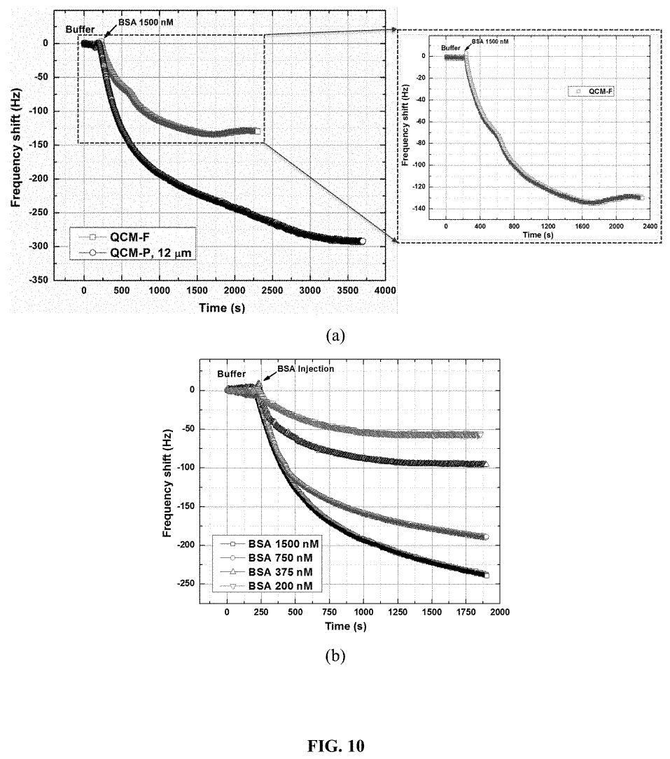

At the beginning of the experiment, phosphate-buffered saline (PBS) buffer was injected into the flow cell at 100 μL/min constant flow rate. After stable frequency baseline was obtained in PBS, the BSA solution was injected into the flow cell at the same flow rate. After injection of BSA, adsorption started and eventually reached equilibrium while the resonant frequencies were recorded. Here, the QCM-F and QCM-P glued with pillar height of 12 μm were treated with oxygen plasma for 10 second to modify them to superhydrophilic surface. Then, these two sensors were used to measure BSA with concentration of 1500 nM as shown in FIG. 10(a). The QCM-F showed a frequency shift of 130 Hz, while the shifts from QCM-P increased and reached the maximum value of 293 Hz. FIG. 10(b) shows that the glued QCM-P is capable of measuring BSA with concentrations as low as 200 nM while the glued QCM-F has no response to the BSA concentration of 750 nM and below.

Applicant's disclosure is described herein in preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of Applicant's disclosure may be combined in any suitable manner in one or more embodiments. In the description, herein, numerous specific details are recited to provide a thorough understanding of embodiments of the invention. One skilled in the relevant art will recognize, however, that Applicant's composition and/or method may be practiced without one or more of the specific details, or with other methods, components, materials, and so forth. In other instances, well-known structures, materials, or operations are not shown or described in detail to avoid obscuring aspects of the disclosure.

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### Equivalents

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

1. A quartz crystal microbalance resonator, comprising:
a replaceable layer of a resonant material; and
a quartz oscillator having a surface and having electrical input terminals, wherein
the replaceable layer of a resonant material is glued to the surface of the quartz oscillator, and
the quartz crystal microbalance resonator having at least one characteristic resonant frequency.

2. The quartz crystal microbalance resonator of claim 1, wherein the replaceable layer of a resonant material is releasably glued to the surface of the quartz oscillator.

3. The quartz crystal microbalance resonator of claim 1, wherein the replaceable layer of a resonant material is not releasably glued to the surface of the quartz oscillator.

4. The quartz crystal microbalance resonator of claim 1, wherein the replaceable layer of a resonant material is a flat film of substantially uniform thickness.

5. The quartz crystal microbalance resonator of claim 4, wherein the replaceable layer of a resonant material has a substantially uniform thickness in the range from about 1 μm to about 10 μm.

6. The quartz crystal microbalance resonator of claim 1, wherein the replaceable layer of a resonant material comprises a plurality of micropillars of the resonant material in an array, each of the micropillars having a diameter, a length, and a spacing, the plurality of micropillars in mechanical communication with the surface of the quartz oscillator.

7. The quartz crystal microbalance resonator of claim 6, wherein the at least one characteristic resonant frequency has a dependence on one or more of the diameter, the length, and the spacing of the plurality of micropillars.

8. The quartz crystal microbalance resonator of claim 7, wherein the length of the plurality of micropillars is substantially uniform and is in the range from about 1 μm to about 30 μm, the diameter of the plurality of micropillars is substantially uniform and is in the range from about 1 μm to about 25 μm, and the spacing of the plurality of micropillars is substantially uniform and is in the range from about 2 μm to about 40 μm.

9-10. (canceled)

11. The quartz crystal microbalance resonator of claim 1, wherein the resonant material comprises a polymer.

12. The quartz crystal microbalance resonator of claim 11, wherein the resonant material comprises polymethyl methacrylate (PMMA).

13. (canceled)

14. The quartz crystal microbalance resonator of claim 1, wherein the replaceable layer of a resonant material is releasably glued to the surface of the quartz oscillator by a UV-curable glue.

15. The quartz crystal microbalance resonator of claim 14, wherein the UV-curable glue is a Norland optical adhesive.

16. The quartz crystal microbalance resonator of claim 1, wherein the replaceable layer of a resonant material is releasably glued to the surface of the quartz oscillator by a hot-pressed glue.

17. The quartz crystal microbalance resonator of claim 16, wherein the hot-pressed glue is a Norland optical adhesive.

18. The quartz crystal microbalance resonator of claim 1, wherein the quartz crystal microbalance resonator is configured to operate in contact with a fluid medium.

19-20. (canceled)

21. The quartz crystal microbalance resonator of claim 1, wherein the quartz crystal microbalance resonator is configured to modify the at least one characteristic resonant frequency in response to a quantity of adsorbed material on the replaceable layer.

22. An article of manufacture comprising a quartz crystal microbalance resonator of claim 1.

23. A method for fabricating a quartz crystal microbalance resonator, comprising
providing a quartz oscillator having a surface and having electrical input terminals;
providing a nanoimprint lithography mother mold;
providing a transfer mold using the nanoimprint lithography mother mold as a template;
preparing a replaceable layer of a resonant material using the transfer mold; and
gluing the replaceable layer of a resonant material to the surface of the quartz oscillator.

24-39. (canceled)

40. A method for detecting or measuring humidity, comprising:
contacting an environment to be tested for humidity with a quartz crystal microbalance resonator of claim 1; and
measuring a frequency response of the quartz crystal microbalance resonator to detect or measure the humidity of the environment

41. A method for detecting or measuring protein absorption, comprising:
contacting a protein to be tested for absorption with a quartz crystal microbalance resonator of claim 1; and
measuring a frequency response of the quartz crystal microbalance resonator to detect or measure protein absorption.
